(19) United States
(12) Patent Application Publication
(10) Pub. No.: US 2012/0316919 A1
(43) Pub. Date: Dec. 13, 2012

(54) SYSTEMS AND METHODS FOR BUY AND HOLD PRICING

(76) Inventors: Cem Vardar, Tempe, AZ (US); James Andrew Sills, Scottsdale, AZ (US)

(21) Appl. No.: 13/157,159

(22) Filed: Jun. 9, 2011

(51) Int. Cl. G06Q 10/00; G06Q 30/00

(52) U.S. Cl. 705/7.31; 705/7.37

(57) ABSTRACT

Methods and systems for calculating parameters for a transaction that includes item purchase, item storage, and item sale, by receiving input parameters related to the transaction and executing a software module that is responsive to at least some of the input parameters to concurrently calculate optimized or maximized output transaction parameters comprising purchase cost of items, selling price of items, and item inventory forecasts, while meeting tradeoffs between or among, and meeting constraints relating to, the output parameters.

### RELATED APPLICATIONS

This application is related to U.S. Pat. No. 7,853,473, entitled “Market-Based Price Optimization System,” filed Aug. 31, 2004; U.S. application Ser. No. 12/014,626, entitled “Price Optimization System for Recommending Product Price Changes to a User Based on Analytic Modules Calculating Price Recommendations Independently” filed Jan. 15, 2008; application Ser. No. 12/014,640 (abandoned), entitled “Price Optimization System And Process For Recommending Product Price Changes To A User Based On Numerical Endings Of Prices” filed Jan. 15, 2008, and U.S. application Ser. No. 12/014,606 (abandoned), entitled “Price Optimization System And Process For Recommending Product Price Changes To A User Based On Unit Size, Price And Margin” filed Jan. 15, 2008.

### FIELD

The embodiments disclosed herein relate to the field of retail pricing and particularly to recommending a price for an inventory of items to meet certain objectives of the seller.

### SUMMARY

Sellers often have the opportunity to buy a large quantity of an item at a reduced cost. This large quantity, or inventory, is stored in a warehouse, sometimes at a low cost, or a no cost, basis for a period of time. However, after that period of time, storing the inventory can result in storage costs, storage cost increases, or other expenses, sometimes referred to as an inventory penalty. In other scenarios, sellers may purchase inventory for their warehouse and need to know weeks of supply in the warehouse in order to allocate that inventory optimally to the seller's stores. Consequently, sellers attempt to sell the inventory within a given time period to avoid storage costs or to allow optimal distribution. Sellers will sometimes implement a Temporary Price Reduction (“TPR”) while the inventory lasts if it is believed this will facilitate either of the foregoing, or other, advantageous scenarios. This strategy is sometimes referred to as “buy and hold” (“BAH).” However, setting a price that will encourage buyers to purchase inventory so that it will be substantially exhausted by the end of a given period of time, but at an acceptable profit margin for the seller, has been a pricing and forecasting problem.

Disclosed is a method and system to recommend an optimal BAH price for a seller's TPR so that inventory to be sold at the TPR is substantially depleted by a given end date. If no end date is specified by the seller, then the embodiment will recommend an optimized price for the given cost and the BAH TPR strategy specified. The terms “retailer,” “seller,” and “user” are used interchangeably herein.

### DESCRIPTION OF THE DRAWINGS

Some embodiments are illustrated by way of example and not limitation in the figures of the accompanying drawings, in which:

FIG. 1 illustrates the operation of a buy and hold TPR.

FIG. 2 illustrates late sell through and early sell through in a buy and hold TPR.

FIG. 3 illustrates a state diagram of a buy and hold TPR according to an embodiment of the inventive subject matter disclosed herein.

FIG. 4 illustrates a system according to an embodiment of the inventive subject matter disclosed herein.

FIG. 5 illustrates a flow diagram according to an embodiment of the inventive subject matter disclosed herein.

FIG. 6 shows a block diagram of an information processing system according to an embodiment of the inventive subject matter disclosed herein.

### DETAILED DESCRIPTION

In the following detailed description of the preferred embodiments, reference is made to the accompanying drawings that form a part hereof, and in which are shown by way of illustration specific embodiments in which the inventive subject matter may be practiced. It is understood that other embodiments may be utilized and structural changes may be made without departing from the scope of the inventive subject matter hereof.

The leading digit(s) of reference numbers appearing in the Figures generally corresponds to the Figure number in which that component is first introduced or most fully described. Signals and connections may be referred to by the same reference number or label, and the actual meaning will be clear from its use in the context of the description.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired.

There can be two or more scenarios in which the described embodiments can find use:

First: The seller specifies the inventory amount and the cost. In this case the disclosed system will recommend the optimal price for the given price elasticity (“PE”) strategy and competitive price index, and then calculate the end date based on the sales forecast at that price.

Second: The seller specifies the inventory amount, cost, and end date. In this case the disclosed system will recommend the price that will substantially exhaust the inventory by the end date.

Other embodiments include finding the best prices to maximize the seller's objective with the seller's order quantity fixed, or finding the best order quantity to maximize the seller's object with seller's cost of goods fixed. Additionally, price can be optimized such that certain rules are enforced such as competitive price index, minimum margin, buyer's price per unit relationships between different package sizes, and good-better-best relationships. The optimized price can be multi-tiered such as 1 for $2 or 2 for $5, and the like. Further, the price can be offered only to loyalty customers of the seller.

The methods and systems described herein can operate on any of several bases in which the seller provides the system with input information related to the BAH temporary price reduction. For example, the seller may provide a weekly, or a daily, load of inventory data, such as the amount of inventory remaining. Also, the seller may provide a weekly or daily load of item-zones and specify begin and end dates. Weekly or daily optimization data could also be supplied by the seller for automated optimization. As used herein, the term “zone” is used in a retail sense, as a grouping of stores for a retailer (not necessarily a geographical zone). Some retailers manage prices in stores within a “zone” as a group rather than managing each store's prices individually. The same prices and price changes usually get applied to all the stores within a “zone”.

The buy and hold algorithm of one embodiment determines an “optimal” price for a BAH item for a zone and that price becomes applied to all the stores within that zone. The system and methods described can also provide the seller with the opportunity to override the recommended BAH price or override the end date of the TPR. Further, on-demand optimization and export of prices to the seller can be provided, as well as export of distribution center allocation to the seller's stores based on the sales history of the stores and/or on the recommended BAH prices for the TPR. The disclosed embodiments may inform the seller of price, sales and date, among other things, by providing information for rendering inventory graphs and rendering of other relevant data, and the seller can be given the option to initiate re-optimization of the recommended process to meet the desired end date, or for the calculation of a new end date. As new data is supplied by the seller, the disclosed embodiments can calculate new recommended prices. The disclosed embodiments can be methods operated by one or more computer processors executing various software modules.

In one embodiment the method adjusts the time period for price reduction based on the inventory or price based on end-date. This is a request to add a new inventory-based TPR. The system can calculate the sales-rate utilizing the forecast and use that to calculate the end-date for the TPR. Similarly, the user can specify the end-date and optimize the price so that the inventory is substantially exhausted by that end-date. That is, the TPR can either be to optimize price for a given end-date, or to optimize price for the given strategy and calculate the end-date when the inventory is exhausted. The user has the option to switch between the two options if desired.

In another embodiment, the seller, or retailer, can take a forward position on inventory. This inventory can be held at the wholesaler's, or supplier's, warehouse or at the seller's distribution center or the seller's warehouse. In this circumstance, the customer (retailer) may take a truckload of inventory, buy it, and hold it in the supplier's warehouse and then distribute it as needed to various of the seller's stores. Both the seller's warehouse and the wholesaler's warehouse can be used for BAH. A mapping of store to distribution center can be used to implement this. The distribution for both the seller's warehouse and the wholesaler's (or supplier's) warehouse can be enterprise wide. Each will basically run a TPR program with a TPR price for as long as there is inventory in its warehouse with that lower cost basis. When that inventory is depleted, the TPR will end and the price will revert back to either an everyday price or another TPR price. This is a quantity limitation on TPRs.

In another embodiment, the system recommends quantity of the forward position inventory as well as the optimal buy and hold prices. In this circumstance the seller is planning for a buy and hold event in the future and has not yet decided how much to order from the wholesaler. Optimization recommendation takes various possible volume discounts offered by the wholesaler into account. For example the wholesaler might be offering an even more discounted price if the seller orders more than a threshold quantity. In this embodiment the system evaluates different order quantity options and corresponding optimal prices and recommends an optimal order quantity coupled with BAH prices.

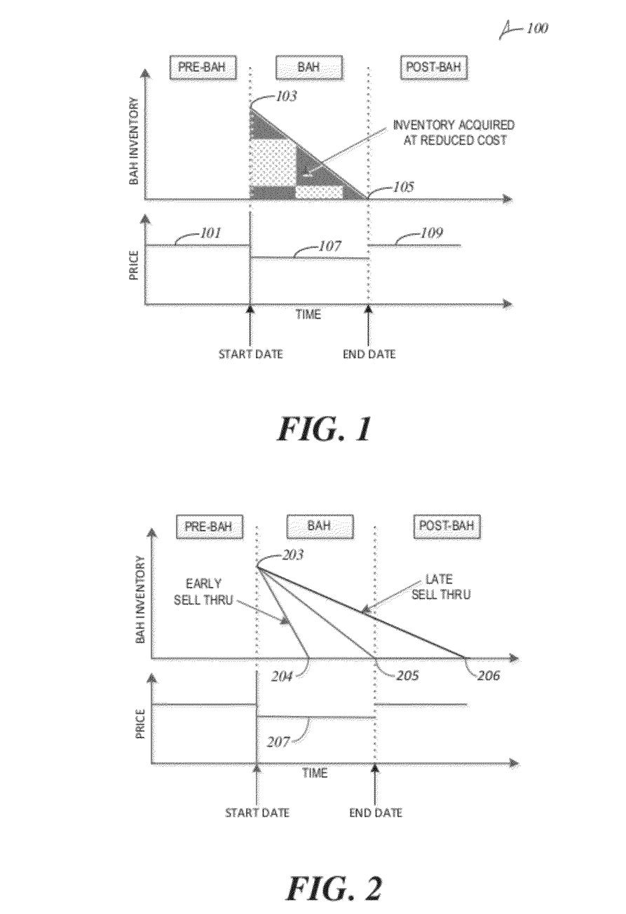

As shown in FIG. 1, BAH TPR is characterized by a TPR price, start date, and end date. This is illustrated in terms of inventory acquired at reduced cost and sold from a certain start date, with the objective of selling the inventory at a certain end date. For the seller, a BAH price that results in a desired profit margin is also a desired attribute of BAH. FIG. 1 illustrates Time along the abscissas. The ordinates illustrate BAH Inventory and also Price. Price 101 will be at a certain amount before the BAH is begun (“Pre BAH”). Inventory is acquired at a reduced cost for the BAH to begin at the Start Date. At the Start Date there will be a certain amount of stored inventory 103. Price 107 is the BAH price, less than the usual price 101, that is recommend to substantially exhaust the inventory at or in close proximity to the End Date. This is illustrated at 105 where the inventory is substantially exhausted, and the time is near the End Date. After the End Date, the price can be increased if desired, as at 109.

An objective of BAH optimization is to minimize late sell-through and early sell-through as seen in FIG. 2. FIG. 2 has the same abscissas and ordinates as FIG. 1, with maximum inventory illustrated at 203, and with Start Date, End Date and Price being illustrated similarly as in FIG. 1. If the BAH price 207 is not optimal, there can be an Early Sell-Through with the inventory being substantially exhausted before the End Date as at 204 instead of the inventory being substantially exhausted at or in close proximity to the End Date as at 205. If the BAH price 207 is not optimal, there can also be a Late Sell-Through, with the inventory being substantially exhausted after the End Date as at 206.

Instead of choosing to deplete the inventory by a given end date, the user might put a limit on total inventory holding cost through the whole period or after a certain cutoff date, or end date, while maximizing revenue. In this scenario the user specifies a holding cost rate for BAH item and optimization recommends prices to maximize revenue while obeying total inventory holding cost constraint, notwithstanding the ending date.

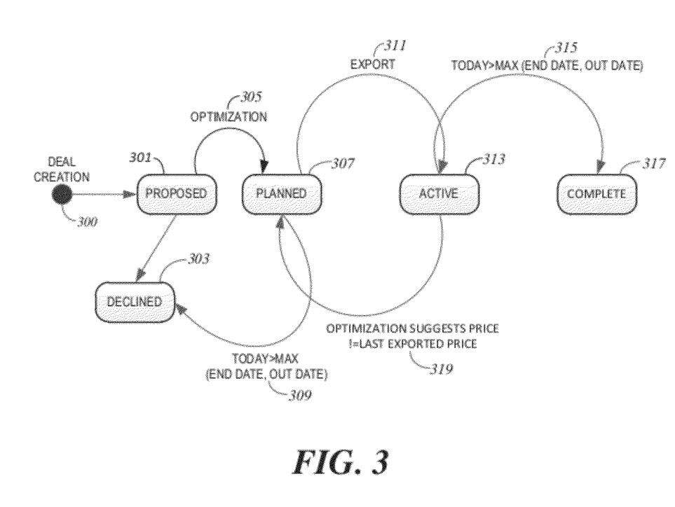

FIG. 3 illustrates a state diagram for a BAH TPR lifecycle. When the BAH TPR is over, then the item becomes available for optimization to recommend a new regular price. In this particular example, the BAH TPR event is not complete until the BAH inventory is substantially zero. At 300 the deal outlined above, meaning at least inventory, cost, and dates, has been created. When a BAH TPR is proposed as at 301, the parameters of the BAH TPR deal outlined above have been loaded into a computer module, discussed in more detail below, but optimization has not yet run. Declined, 303, means that the recommended BAH price was, for any reason, never exported and the end date is now past. At 305 BAH price optimization is run by the computer module and the state moves to the Planned state, 307. Planned means optimization has run and recommended a price change different than current or last exported price. Step 307 proceeds to the Declined State if the current date is after the End Date. If the current date is not after the End Date, then step 311 proceeds to Active state 313, meaning the item zone has been exported. Exporting the prices for an item zone exports prices, usually for all the stores within that item zone. If the exported price is acceptable, then Step 315, representing the latest of the End Date or the date that at which inventory is substantially exhausted, proceeds to Complete 317. If the user reoptimizes and the system recommends price changes different than the exported prices, then the state changes to Planned. If the system does not recommend a different price, state remains Active.

An algorithmic example of the above BAH Lifecycle can be stated as:

```
If TodaysDate>Max(BuyAndHold.Deal.EndDate,
BuyAndHold.DealResult.ForecastEndDate)
&& BuyAndHold.Deal.Status = Active
    change the status of that zone to Completed.
If (TodaysDate > Max(BuyAndHold.Deal.EndDate,
BuyAndHold.DealResult.ForecastEnd
Date)
&& BuyAndHold.Deal.Status = Proposed or Planned
    change the status of that zone to Declined.
```

Every deal starts at a Proposed state when they are first created in the system. The optimization module runs and recommends price changes and moves the deal to a Planned state. The seller reviews optimization recommendations and exports the recommended price. This moves the deal to an Active state meaning that the recommended prices have been implemented. The seller has the option of optimizing again in the subsequent weeks. If the optimization recommends prices different than what has been exported (implemented), the system moves the deal back to a Planned state. At this point the user again has the option of exporting the new prices if he/she desires. Every deal reaches a terminating state of Completed (deals at Active state) or Declined (deals at Proposed or Planned state) at either at the End Date or inventory exhaustion date whichever comes last.

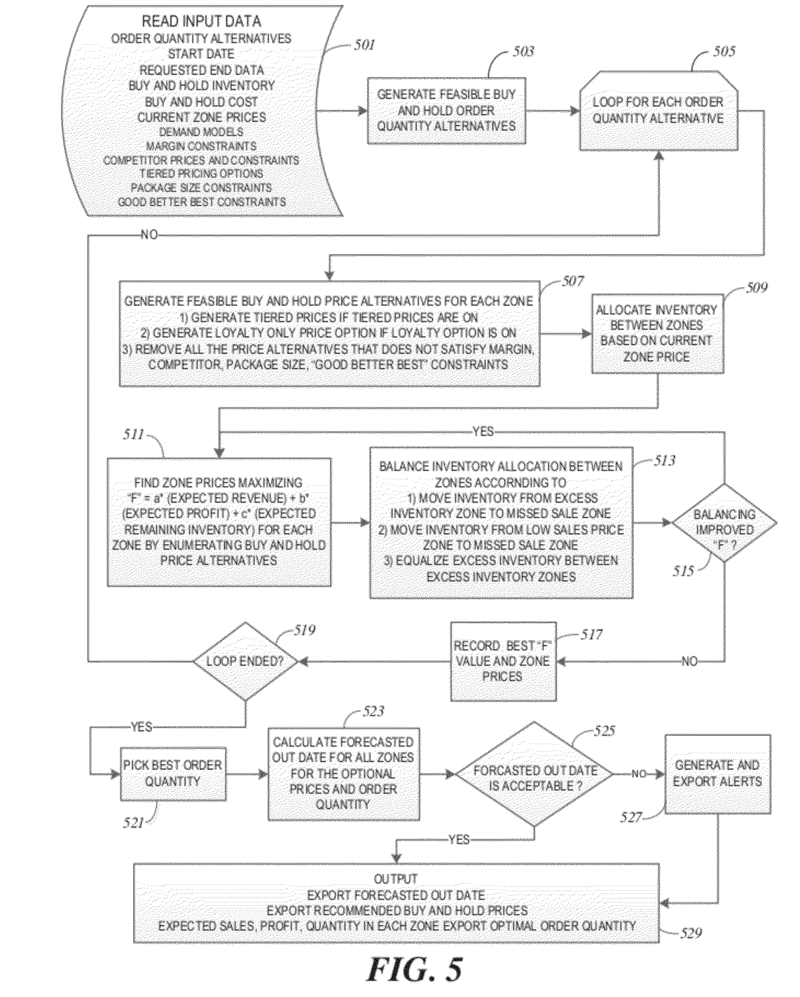

The system will use a markdown optimization engine, discussed in additional detail with respect to FIG. 5. Based on the start date, end date, deal cost and current prices the System will create an optimization problem and solve for the optimum prices in each zone to maximize the revenue while obeying the end date constraint. The System will also calculate the necessary allocations to the stores within the zones of the deal to supply enough BAH inventory to meet the demand for suggested prices. If the system cannot meet the constraint of depleting the BAH inventory before the end date, the system can issue a low sell-through alert.

The following is an algorithmic example of optimizing price with no end date specified by the seller. The markdown optimization engine will use PE pricing parameters to optimize the price of BAH item based on the deal cost. For example PE pricing parameters such as price elasticity coefficient and reengineered price image coefficient can be used.

The following algorithm steps may be used:

Step 1: Adjust the price of the BAH item according to new cost, λ.

$${p}_{i}^{*} = \frac{{c}_{i}}{1 + λ} + \frac{1}{{β}_{i}}$$

### Where

p*ᵢ is the recommended BAH price for item i,
c(i) is the BAH hold cost for item i,
β(i) is the price elasticity coefficient for item (i), and
λ is the reengineered price image coefficient for the product sub category that the item i is in.
   Step 2: Validate the price based on the BAH rules (e.g. AHMinMargin %,BAHMinDiscount)
   Step 3: Iterate through all stores to calculate the forecast
   Step 4: Perform store allocations based on the store forecasts. Simple allocation weighted by forecast for each store.
   Step 5: Calculate total demand and estimate end date.
   Step 6: Calculate and export daily forecast (for item details graphs).

The following is an algorithmic example of optimizing price with an end date specified by the seller. The markdown optimization engine will compute the optimal pricing for exhausting the inventory at or proximate to the end date. BAH with end dates with the objective of moving the inventory is analogous to a markdown event that has a single item with BAH start and end dates corresponding to markdown event start and end dates. While any number of algorithmic rules can be used for this markdown, the following is one example of rules that can be used:
Usually, only one markdown is taken at the start of the event
All stores in a zone will take the same markdown.
The markdown objective is to minimize inventory on hand at the end date.
A price increase to regular price might be allowed during the BAH the event

The following algorithm steps may be used:
Step 1: Run markdown optimization with store allocation for a BAH item.
Step 2: Iterate through all stores to calculate the forecast
Step 3: Calculate the total demand and estimate the end date
Step 4: Check for alerts
Step 5: Calculate and export a daily forecast

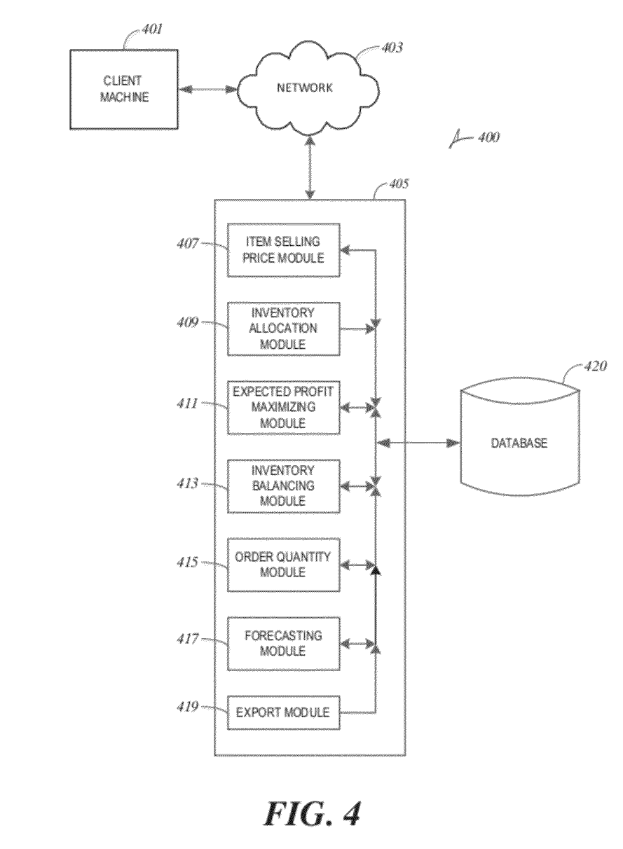

One embodiment or performing the above algorithms is the server system seen generally at 400 in FIG. 4. System server 405 is connected via a network, such as the Internet 403, to a client machine 401 operated by the seller. Server 405 is connected to database 420.

Server 405 comprises several modules executed by one or more computer processors. Modules include Item selling price module 407, inventory allocation module 409, expected profit maximizing module 411, inventory balancing module 413 and export module 415. Each of the modules is connected to database 410 by way of an appropriate communication interface.

Database 420, stored in computer disk storage or other suitable computer storage, includes appropriate tables for storing data for use in carrying out the above algorithms. For example, such tables may include a table listing the inventory types in the seller's distribution center; a table for storing the seller's distribution center inventory history; a table identifying the new inventory for buy and hold; a table storing the various types of alerts exported to the seller; a table storing the buy and hold deal including such things as cost, start date, end date, and the like, which could be loaded and maintained by the seller. Tables could also include a table for holding the results of the buy and hold event, including forecasts, BAH prices (also referred to as “item selling prices”) for selling the item by a seller, forecast quantity, current inventory, and current inventory item selling prices, among others, populated by the system during optimization; a table for buy and hold store results, populated by the system during optimization; a table for buy and hold deal zone, populated by current price, current cost of the buy and hold item, loaded and maintained by the seller; a table for buy and hold dealzone results, populated by the system during optimization; a buy and hold rule table for rule names, descriptions, and the like, based on configuration data discussed above; one or more tables for rule sets which can be maintained by the seller; and a table for buy and hold status based on the state logic described above with respect to FIG. 3.

In operation, the seller transmits input data such as start date, end date, inventory, cost, current zone prices, demand models and margin constraints related to a buy and hold event, from client machine 401 to server 405 via the network 403, which may be the Internet. In response, the item selling price module 407 generates feasible BAH price alternatives for each zone and the inventory allocation module 409 allocates inventory among zones. The expected profit maximizing module 411 and the inventory balancing module 413 then operate to maximize the seller's objective for the buy and hold event. When the objective is met the system can calculate the forecasted end date for each zone, using a module such as forecast module 417, and, if the forecasted end date is acceptable, the export module 419 transmits the results for rendering at the seller's client machine 401. If the forecasted end data is not acceptable, meaning that it does not meet the seller's specified end date, the system issues an alert indicating this fact, again using a module such as export module 419, also for rendering at the client machine.

The algorithm steps set forth and discussed above may be more easily seen with respect to FIG. 5 which is a flow chart of an exemplary method 500 for carrying out one embodiment. As discussed earlier, the seller may send certain input data to the system. This could be done via a seller client machine over the Internet to the system. At 501, the system reads the input data which comprises

Start Date: which is the buy and hold event start date. That is, the date that buy and hold prices will be implemented in the seller's zones.

Requested End Date: This is the date the seller wants inventory to be depleted.

Buy And Hold Inventory: This is the amount of buy and hold inventory in a distribution center, for example, that will be allocated to the zones and sold during the buy and hold event.

Buy And Hold Cost: This is the unit item cost for the buy and hold event.

Current Zone Prices: These are the prices currently active in the zones.

Demand Models: These are the demand models for each zone relating price to weekly expected sales.

Margin Constraints: These are minimum or maximum margin constraints that sellers want the buy and hold prices to obey.

Ending number constraints: The user can specify ending number constraints to limit the price changes to obey their ending number policies.

Competitor prices and constraints: The user might specify competitor prices for the BAH item and constrain the system to keep the BAH prices at a predetermined level compared to competitor prices. (i.e. prices cannot be cheaper or more expensive than competitor X by a given percent (%))

Tiered pricing options: The user might specify tiered pricing options such as 1 for $2 or 2 for $5.

Package size constraints: The user might specify BAH price to obey some price constraints where BAH price has to be within a price range compared to other package sizes of the same product.

Good better best constraints: The user might specify BAH price to obey some price constraints where BAH price has to be within a price range compared to other brands of the same product. (i.e. a private brand has to be at least X % cheaper than a national brand)

Box 501 indicates user input data, or user input parameters, sent from client machine 401 as signals sent to system server 405 over network 403 which may be the Internet. In what may be considered an initialization, at 503 the system may generate the order quantity alternatives as at order quantity module 415. In the scenarios where order quantity is not being optimized this step may generate an alternative where order quantity equals to current inventory level at the warehouse. 505 is the start of a loop where each order quantity alternative is optimized and results of the optimization is recorded into storage, such as in database 420 in suitable computer storage. Steps 507 through 519 are performed for each order quantity alternative. At 507 the system generates feasible buy and hold price alternatives for the seller's zones. In this step, based on the current price in each zone, buy and hold cost, and margin constraints, the system may generate a set of feasible prices for each zone. This step is responsible for generating price alternatives while obeying some or all of the following pricing constraints depending on the user preference such as Competitor Price Constraints, Package size constraints, and Good, Better Best constraints. The system, for example at item price module 407, generates possible pricing alternatives and eliminates price alternatives that violate any of the constraints that was turned on (or sent as signals) by the user.

At step 509, the system allocates inventory between each zone based on current zone price, for example by inventory allocation module 409. In this step the system allocates a distribution center buy and hold inventory between the seller's zones weighted by the expected demand for each zone at the current price. Expected demand is calculated through use of a demand model which is a seller input to the BAH system. It could be any generic demand model that relates price to an expected demand quantity.

At step 511 the system, as at item selling price module 407, finds optimal prices based on the current item allocation. In this step the system enumerates pricing alternatives for each zone to find the pricing alternative that maximizes the following transaction objective function:

F=aP+bS+cI

where:
P=Total expected profit=expected demand (p)*(p−buy and hold cost),
p is the buy and hold price for the current pricing alternative, expected demand (p) is estimate demand for an item at price p,
S=Total expected sales=expected demand (p)*(p),
p is again the buy and hold price for the current pricing alternative,
I=expected inventory remaining at the end of the BAH event=BAH Quantity−expected demand (p)
a, b, c are objective function weights which allows the seller to represent different strategies
Inventory penalty=left over inventory at the requested end date*buy and hold cost*penalty coefficient
The penalty coefficient is an algorithm tuning parameter for balancing the inventory depletion objective with the profit. It is set based on the seller's inventory holding cost accrual strategies.

The following are examples of applying a, b, and c as objective function weights:
a=1, b=0, c=10 represents a strategy where depletion of inventory at the end date is very important to the seller or
a=1, b=10, c=0 represents a strategy where seller want to drive traffic to their stores while not giving much importance to profit and when the inventory is depleted.
   The system allows the user to set these weights, as at read input data box 501, based on the strategy the user wants to employ. The weights are user specified inputs and are determined based on the business strategies and priorities of the seller for the BAH event.

At step 513 the system balances the inventory allocation among zones, such as at inventory balancing module 413, and inventory allocation module 409 (which may comprise a single module) In this step of the algorithm the system balances the inventory allocation among zones to improve the objective function. To achieve this, the system, in one embodiment, determines the following inefficiencies in the current solution and moves allocated inventory among the seller's zones. For example, the system can recommend moving inventory from an excess inventory zone to missed sale zone. In other words, the system searches the zones to find zones with excess inventory and recommends moving that excess inventory to zones that have missed sales. The system may also recommend moving inventory from a low sales price zone to a missed sale zone. In this step 513 the system determines zones that have sales at a lower price than another zone which has missed sales at a higher price. Finally, the system may equalize excess inventory between zones that have excess inventory. For example, if two zones each have excess inventory the system can move allocated inventory from a zone that has high excess inventory to a zone that has low excess inventory to equate the amount of excess inventory that both zones have.

At step 515, the system checks for improvement. At this step the system checks to determine whether step 513 improved the objective function F, discussed above. If the answer is yes, then the Yes branch is taken and the system repeats steps 511 and 513. Step 515 checks again for an improved objective function. If the answer is yes, the Yes branch is again taken and steps 507 and 509 are repeated. This continues until the objective function is no longer improved, at which point the No branch is taken from step 515 and the process continues to 517 using the result from the pass just previous to the final pass through the loop.

Step 517 records, for example in database 420, the optimal objective function value (value of F) and optimized prices for the order quantity being evaluated and moves on to 519 if there is any other order quantity alternatives left to be optimized and evaluated. If there are one or more quantity alternatives to be evaluated system goes back to the start of the loop to 505 and repeats that algorithm between 507 and 517. If there are no other alternatives to be evaluated the process continues on to step 521 to find the best order quantity, as at order quantity module 415. At this step the system picks the order quantity alternative with the best F value and moves on to step 523 to perform final calculations.

Step 523 calculates, for example at forecast module 417, the forecasted end date (or “out” date) for the zones. That is, based on the current zone price and inventory allocation the system calculates the expected date that the inventory will be depleted for each zone. Demand models relating prices to weekly expected demand and inventory levels are used to calculate the out date.

Step 525 checks to determine whether the forecasted out date is acceptable. At this step the system compares the out date for each zone with the seller's requested end date. If the forecasted out date is not close enough (based on a tolerance parameter set by the seller) the system generates an alert, sometimes called an export alert, to the seller, as at step 527, to indicate a possible action required for this buy and hold event. For example, based on the expected out date being early or late, the system could generate a low or high inventory alert

If the forecasted out date is acceptable the system proceeds to step 529 where export alerts may be generated. That is, the output data is exported to the seller. The following output data may be exported:
Forecasted out date: Forecasted inventory depletion date based on the system-recommended buy and hold prices.
Buy and hold (i.e., item selling) prices: Optimal buy and hold prices for each zone.
Expected sales: expected revenue in dollars during the event for each zone.
Expected profit: expected profit in dollars during the event for each zone.
Expected revenue: expected quantity sold in units during the event for each zone.

For finding the best prices to maximize F with the order quantity fixed step 503 generates a single alternative where order quantity is equal to the fixed value. In this scenario loop through 505-519 is only performed once. Other parts of the algorithm remains the same.

For finding the best order quantity to maximize F with price fixed, optimization of BAH prices 511-513 is skipped and F is calculated using the fixed prices. The other parts of the algorithm remains the same.

The following three examples illustrate operation of an embodiment generating parameter for a BAH TPR.

### Example 1

A vendor offers a retailer a special cost of $8 per case for a box car of Campbell's tomato soup. This compares to the regular cost of $12 per case. A box car equals 1000 cases and each case is 32 items. The retailer accepts the offer. The retailer puts the cases of soup in their warehouse so there is no carrying cost and since the canned soup has a long shelf life, no end date is specified. User specifies no Margin constraints The following information is sent to the system:

| Header | Value |
|---|---|
| Product UPC | 0101010123 |
| Distribution Center | Warehouse_1 |
| B&HCost | $0.33 |
| StartDate | January 1, 2011 |
| EndDate | NULL |

The Buy and Hold implementation recommends a $0.39 price for each item and displays an end date of Mar. 12, 2011.

### Example 2

A vendor offers a retailer a special cost of $16 per case for a box car of Kellog's Frosted Flakes. This compares to the regular cost of $24 per case. A box car equals 1000 cases and each case is 24 items. The retailer accepts the offer. The retailer puts the inventory in a co-op warehouse such that after 6 weeks the retailer must begin paying carrying costs. An end date is specified for 6 weeks after the start date. User specifies 20% margin constraint and ending price constraint of prices ending with 29 49 69 or 99 cents. The following information is sent to the system:

| Header | Value |
|---|---|
| Product UPC | 0101010123 |
| Distribution Center | Warehouse_2 |
| B&HCost | $0.67 |
| StartDate | January 1, 2011 |
| EndDate | February 4, 2011 |

The Buy and Hold implementation attempts to recommend a $0.79 price for each item, however this violates the minimum margin of 20%. Instead a price of $0.99 is recommended because this is the nearest ending number above $0.80 that meets the user's ending price constraint. Since the end date cannot be satisfied at this higher price, the user can be alerted and recommended to take a later end date. The user accepts the revised end date. The user exports the store-level allocation of inventory and sends this to the warehouse.

The following variations are on Example 2:

1. The BAH inventory is available for one warehouse that serves a subset of zones. In this case, the price recommendation is limited to just those zones served by the warehouse.

2. The warehouse does not serve all stores in all zones. In this case, price is recommended by item-zone-vendor with the warehouse being the vendor. The warehouse must be the primary vendor for the stores supplied by the warehouse.

3. On Jan. 21, 2011, the retailer observes an alert indicating that the sell thru is lower than expected. The retailer overrides the price to $0.59, which results in a forecasted end date that is on target. When the user overrides the price, there are no prompts to change the price across the price family; that is, the user must change the price one item-zone-vendor at a time.

4. On Jan. 21, 2011, the retailer observes an alert indicating that the sell-through is higher than expected. The retailer re-optimizes the item, which remains at $0.99. However, the end date is pulled forward.

### Example 3

A vendor offers a retailer a special cost of $12 per case for a box car of Colgate tooth paste. This compares to the regular cost of $16 per case. A box car equals 1000 cases and each case is 24 items. In addition vendor offers an additional volume discount $11 per case if seller orders 2 box cars or more. The vendor will put the inventory in a co-op warehouse such that after 8 weeks the retailer must begin paying carrying costs. An end date is specified for 8 weeks after the start date. User specifies 20% margin constraint. The following information is sent to the system:

| Header | Value |
|---|---|
| Product UPC | 1010101222 |
| Distribution Center | Warehouse_2 |
| Start Date | February 1, 2011 |
| End Date | March 31, 2011 |
| B&H Cost | 0.5 |
| B&H Cost Volume Discount | 0.458 |
| Volume discount threshold | 48000 cases |

The Buy and Hold implementation recommends ordering 3 box cases and price of $0.75 and a buy 5 for $3 promotion. Forecasted end date Apr. 5, 2011 which inside the tolerance set by the user for meeting the end date requirement and no alerts are generated.

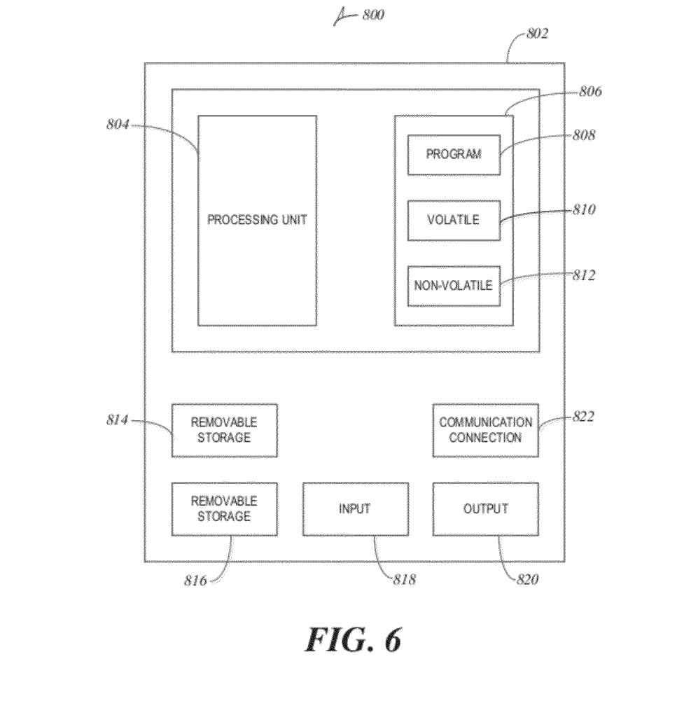

A block diagram of an information processing device capable of executing programming for performing the above methods is shown in FIG. 6. A general information processing device in the form of a computer 802, includes a processing unit 804, memory 806, removable storage 814, and non-removable storage 816. Memory 806 optionally includes volatile memory 810 and non-volatile memory 812. In various embodiments, computer 802 includes a variety of computer-readable media, such as volatile memory 810 and non-volatile memory 812, removable storage 814 and non-removable storage 816. Computer storage comprises random access memory (RAM), read only memory (ROM), erasable programmable read-only memory (EPROM) & electrically erasable read-only memory (EEPROM), flash memory or other memory technologies, compact disk read-only memory (CD ROM), digital versatile disks (DVD) or other optical disk storage, magnetic cassettes, magnetic tape, magnetic disk storage or other magnetic storage devices, or any other medium capable of storing computer-readable instructions. In various embodiments, computer 802 includes or has access to a computing environment that comprises input 818, output 820, and a communication connection 822. The computer 802 operates in a networked environment using a communication connection to connect to one or more remote computers. The remote computer may include a personal computer, server, router, network personal computer (PC), a peer device or other common network node, a wireless computing device, a personal digital assistant (PDA), a mobile telephone, or the like. In various embodiments, the communication connection 822 includes a local area network (LAN), a wide area network (WAN), the Internet, a virtual private network (VPN), or other networks.

Computer-readable instructions stored on a computer-readable medium are executable by the processing unit 804 of the computer 802. A hard drive, CD-ROM, and RAM are some examples of articles including a computer-readable medium. For example, a computer program 808 capable performing operations in accordance with one or more of the methods of the inventive subject matter disclosed herein can be included on a CD-ROM and loaded from the CD-ROM to a hard drive. The computer-readable instructions allow computer system 802 to provide generic access controls in a computer network system having multiple users and servers, wherein communication between the computers comprises utilizing TCP/IP, HTML, XML, Simple Object Access Protocol (SOAP), Web Services Description Language (WSDL), and other communication protocols that provide the ability of two or more information processing devices to communication with one another.

It is understood that the above description is intended to be illustrative, and not restrictive. Many other embodiments will be apparent to those of skill in the art upon reviewing the above description. The scope of the inventive subject matter disclosed herein should, therefore, be determined with reference to the appended claims, along with the full scope of equivalents to which such claims are entitled.

What is claimed is:

1. A method for calculating parameters related to a transaction that includes item purchase, item storage, and item sale, the method comprising:
using a computer processor and computer storage for:
receiving input parameters related to the transaction; and
executing a software module that is responsive to at least some of the input parameters to concurrently calculate optimized or maximized output parameters comprising purchase cost of items, selling price of items, and item inventory forecasts, while meeting tradeoffs between or among, and meeting constraints relating to, the output parameters.

2. The method of claim 1, the method further comprising, responsive to an input signal indicating the selection of a transaction objective, and an item selling price for optimization, calculating a recommended item selling price that maximizes the transaction objective.

3. The method of claim 2 wherein the item selling price comprises price per unit relationships between differing package sizes.

4. The method of claim 2 wherein the item selling price comprises multi-tiered pricing.

5. The method of claim 2 further comprising, in response to a signal indicating expected demand of loyalty customers, calculating the recommended item selling price based on the total expected demand of loyalty customers.”

6. The method of claim 1, the method further comprising, responsive to an input signal indicating the selection of a transaction objective, and an item selling price for optimization, and to an input signal indicating the selection of an end date by which substantially all of the items are to be sold, calculating a recommended item selling price that maximizes the transaction objective and substantially depletes the number of items by or at a time proximate to the end date.

7. The method of claim 6 wherein the item selling price comprises price per unit relationships between differing package sizes.

8. The method of claim 6 wherein the item selling price comprises multi-tiered pricing.

9. The method of claim 6 further comprising, in response to a signal indicating a number of loyalty customers, calculating the recommended item selling price based on the number of loyalty customers.

10. The method of claim 1, the method further comprising, responsive to an input signal indicating a transaction objective and the selection of a minimum profit margin, calculating a recommended item selling price that maximizes the transaction objective and meets a minimum profit margin.

11. The method of claim 1, the method further comprising, responsive to an input signal indicating a transaction objective, and the selection of a minimum profit margin, and to an input signal indicating the selection of an end date by which substantially all of the items are to be sold, calculating a recommended item selling price that maximizes the transaction objective, meets a minimum expected profit margin and substantially depletes the number of items by or at a time proximate to the end date.

12. The method of claim 1, the method further comprising, responsive to an input signal indicating a transaction objective and one or more price constraints, calculating an item selling price that maximizes transaction objective and meets the one or more price constraints.

13. The method of claim 1, the method further comprising, responsive to an input signal indicating a transaction objective and one or more price constraints, and to an input signal indicating selection of an end date by which substantially all of the items are to be sold, calculating an item selling price that maximizes the transaction objective and substantially depletes the number of items by or at a time proximate to the end date, and that meets the one or more price constraints.

14. The method of claim 1, the method further comprising, responsive to an input signal indicating the selection of expected sales for maximization, calculating an item selling price that maximizes expected sales.

15. The method of claim 1, the method further comprising, responsive to an input signal indicating the selection of expected sales for optimization, and to an input signal indicating the selection of an end date by which substantially all of the items are to be sold, calculating an item selling price that maximizes expected sales and substantially depletes the number of items by or at a time proximate to the end date.

16. The method of claim 1, the method further comprising, responsive to an input signal indicating a transaction objective, and the selection of item inventory depletion for optimization, calculating an item selling price that maximizes the transaction objective and that substantially depletes the number of items.

17. The method of claim 1, the method further comprising, responsive to an input signal indicating a transaction objective and the selection of item inventory depletion for optimization, and to an input signal indicating the selection of an end date by which substantially all of the items are to be sold, calculating an item selling price that maximizes the transaction objective and substantially depletes the number of items by or at a time proximate to the end date.

18. The method of claim 1, the method further comprising, responsive to input signals indicating the selection of seller order quantity, item selling price, and a transaction objective, calculating seller order quantity and item selling price for that order quantity for maximizing the objective.

19. The method of claim 1, the method further comprising, responsive to input signals indicating the selection of seller order quantity, item selling price, and a transaction objective, and the selection of an end date by which substantially all of the items are to be sold, calculating seller order quantity and item selling price for that order quantity that will maximize the objective and that will substantially deplete the number of items by the or at a time proximate to the end date.

20. The method of claim 1, the method further comprising, responsive to input signals indicating a seller order quantity and a transaction objective, calculating an item selling price that will maximize the objective.

21. The method of claim 1, the method further comprising, responsive to input signals indicating a seller order quantity, a transaction objective, and the selection of an end date by which substantially all of the items are to be sold, calculating an item selling price that will maximize the transaction objective and that will substantially deplete the number of items by the or at a time proximate to the end date.

22. The method of claim 1, the method further comprising, responsive to input signals indicating an item selling price and a transaction objective, calculating the seller order quantity that will maximize the transaction objective.

23. The method of claim 1, the method further comprising, responsive to input signals indicating an item selling price and a transaction objective, and the selection of an end date by which substantially all of the items are to be sold, calculating the seller order quantity that will maximize the objective and that will substantially deplete the number of items by the or at a time proximate to the end date.

24. The method of claim 1, the method further comprising generating feasible item selling prices for each of the at least one of the at least one zone.

25. The method of claim 24 wherein the input parameters include a respective current item selling price for a plurality of zones, the method further including providing a signal useful for allocating item inventory among the plurality of zones, based on the respective current item selling price for each of the plurality of zones.

26. The method of claim 1, the method further including:
receiving at least one additional input parameter after providing the user-selectable signal; and
using at least some of the at least one additional input parameter, computing a new recommended item selling price that maximizes a transaction objective expected from the sale of the item for the at least one zone.

27. The method of claim 12 wherein the one or more price constraints includes a competitive price constraint.

28. The method of claim 13 wherein the one or more price constraints includes a competitive price constraint.

29. A non-transitory computer-readable storage medium having embedded therein a set of instructions which, when executed by one or more processors of a computer, causes the computer to execute the following operations:
receiving input parameters related to the transaction; and
executing a software module that is responsive to at least some of the input parameters to concurrently calculate optimized or maximized output parameters comprising purchase cost of items, selling price of items, and item inventory forecasts, while meeting tradeoffs between or among, and meeting constraints relating to, the output parameters.

30. The computer readable medium of claim 29, the operations further comprising, responsive to an input signal indicating the selection of a transaction objective, and an item selling price for optimization, calculating a recommended item selling price that maximizes the transaction objective.

31. The computer readable medium of claim 30 wherein the item selling price comprises price per unit relationships between differing package sizes.

32. The computer readable medium of claim 30 wherein the item selling price comprises multi-tiered pricing.

33. The computer readable medium of claim 30, the operations further comprising, in response to a signal indicating expected demand of loyalty customers, calculating the recommended item selling price based on the total expected demand of loyalty customers.

34. The computer readable medium of claim 29, the operations further comprising, responsive to an input signal indicating the selection of a transaction objective, and an item selling price for optimization, and to an input signal indicating the selection of an end date by which substantially all of the items are to be sold, calculating a recommended item selling price that maximizes the transaction objective and substantially depletes the number of items by or at a time proximate to the end date.

35. The computer readable medium of claim 34 wherein the item selling price comprises price per unit relationships between differing package sizes.

36. The computer readable medium of claim 34 wherein the item selling price comprises multi-tiered pricing.

37. The computer readable medium of claim 34, the operations further comprising, in response to a signal indicating a number of loyalty customers, calculating the recommended item selling price based on the number of loyalty customers.

38. The computer readable medium of claim 29, the operations further comprising, responsive to an input signal indicating a transaction objective and the selection of a minimum profit margin, calculating a recommended item selling price that maximizes the transaction objective and meets a minimum profit margin.

39. The computer readable medium of claim 29, the operations further comprising, responsive to an input signal indicating a transaction objective, and the selection of a minimum profit margin, and to an input signal indicating the selection of an end date by which substantially all of the items are to be sold, calculating a recommended item selling price that maximizes the transaction objective, meets a minimum expected profit margin and substantially depletes the number of items by or at a time proximate to the end date.

40. The computer readable medium of claim 29, the operations further comprising, responsive to an input signal indicating a transaction objective and one or more price constraints, calculating an item selling price that maximizes transaction objective and meets the one or more price constraints.

41. The computer readable medium of claim 29, the operations further comprising, responsive to an input signal indicating a transaction objective and one or more price constraints, and to an input signal indicating selection of an end date by which substantially all of the items are to be sold, calculating an item selling price that maximizes the transaction objective and substantially depletes the number of items by or at a time proximate to the end date, and that meets the one or more price constraints.

42. The computer readable medium of claim 29, the operations further comprising, responsive to an input signal indicating the selection of expected sales for maximization, calculating an item selling price that maximizes expected sales.

43. The computer readable medium of claim 29, the operations further comprising, responsive to an input signal indicating the selection of expected sales for optimization, and to an input signal indicating the selection of an end date by which substantially all of the items are to be sold, calculating an item selling price that maximizes expected sales and substantially depletes the number of items by or at a time proximate to the end date.

44. The computer readable medium of claim 29, the operations further comprising, responsive to an input signal indicating a transaction objective, and the selection of item inventory depletion for optimization, calculating an item selling price that maximizes the transaction objective and that substantially depletes the number of items.

45. The computer readable medium of claim 29, the operations further comprising, responsive to an input signal indicating a transaction objective and the selection of item inventory depletion for optimization, and to an input signal indicating the selection of an end date by which substantially all of the items are to be sold, calculating an item selling price that maximizes the transaction objective and substantially depletes the number of items by or at a time proximate to the end date.

46. The computer readable medium of claim 29, the operations further comprising, responsive to input signals indicating the selection of seller order quantity, item selling price, and a transaction objective, calculating seller order quantity and item selling price for that order quantity for maximizing the objective.

47. The computer readable medium of claim 29, the operations further comprising, responsive to input signals indicating the selection of seller order quantity, item selling price, and a transaction objective, and the selection of an end date by which substantially all of the items are to be sold, calculating seller order quantity and item selling price for that order quantity that will maximize the objective and that will substantially deplete the number of items by the or at a time proximate to the end date.

48. The computer readable medium of claim 29, the operations further comprising, responsive to input signals indicating a seller order quantity and a transaction objective, calculating an item selling price that will maximize the objective.

49. The computer readable medium of claim 29, the operations further comprising, responsive to input signals indicating a seller order quantity, a transaction objective, and the selection of an end date by which substantially all of the items are to be sold, calculating an item selling price that will maximize the transaction objective and that will substantially deplete the number of items by the or at a time proximate to the end date.

50. The computer readable medium of claim 29, the operations further comprising, responsive to input signals indicating an item selling price and a transaction objective, calculating the seller order quantity that will maximize the transaction objective.

51. The computer readable medium of claim 29, the operations further comprising, responsive to input signals indicating an item selling price and a transaction objective, and the selection of an end date by which substantially all of the items are to be sold, calculating the seller order quantity that will maximize the objective and that will substantially deplete the number of items by the or at a time proximate to the end date.

52. The computer readable medium of claim 29, the operations further comprising generating feasible item selling prices for each of the at least one of the at least one zone.

53. The computer readable medium of claim 52 wherein the input parameters include a respective current item selling price for a plurality of zones, the operations further including providing a signal useful for allocating item inventory among the plurality of zones, based on the respective current item selling price for each of the plurality of zones.

54. The computer readable medium of claim 29, the operations further including:
receiving at least one additional input parameter after providing the user-selectable signal; and
using at least some of the at least one additional input parameter, computing a new recommended item selling price that maximizes a transaction objective expected from the sale of the item for the at least one zone.

55. The computer readable medium of claim 40 wherein the one or more price constraints includes a competitive price constraint.

56. The computer readable medium of claim 41 wherein the one or more price constraints includes a competitive price constraint.

57. A system for calculating parameters related to a transaction that includes item purchase, item storage, and item sale, the method comprising:
a computer processor and computer storage configured to:
receive input parameters related to the transaction; and
execute a software module that is responsive to at least some of the input parameters to concurrently calculate optimized or maximized output parameters comprising purchase cost of items, selling price of items, and item inventory forecasts, while meeting tradeoffs between or among, and meeting constraints relating to, the output parameters.

58. The system of claim 57, the computer processor and computer storage further configured to, responsive to an input signal indicating the selection of a transaction objective, and an item selling price for optimization, calculate a recommended item selling price that maximizes the transaction objective.

59. The system of claim 57, the computer processor and computer storage further configured to, responsive to an input signal indicating the selection of a transaction objective, and an item selling price for optimization, and to an input signal indicating the selection of an end date by which substantially all of the items are to be sold, calculate a recommended item selling price that maximizes the transaction objective and substantially depletes the number of items by or at a time proximate to the end date.
